(19) United States
(12) Patent Application Publication
(10) Pub. No.: US 2003/0105636 A1
(43) Pub. Date: Jun. 5, 2003

(54) System and method that randomly makes question and answer sentences for enhancing user's foreign language speaking and listening abilities

(76) Inventors: Sayling Wen, Taipei (TW); Zechary Chang, Taipei (TW); Pinky Ma, Beijinh (CN)

Correspondence Address: BIRCH STEWART KOLASCH & BIRCH, PO BOX 747, FALLS CHURCH, VA, 22040-0747, US

(21) Appl. No.: 10/000,295

(22) Filed: Dec. 4, 2001

(51) Int. Cl. G10L 21/00; G10L 11/00

(52) U.S. Cl. 704/270

(57) ABSTRACT

A system that randomly makes question and answer sentences for users to enhance their foreign language speaking and listening abilities and the method for the same. A user can use the disclosed system to complete his or her answers to the questions following hints provided by the system. The disclosed method includes the steps of: establishing at least one sentence pattern sample in a sentence pattern database; outputting a question through a question-generating module; outputting the question in writing or speaking to the user through a sentence-making language-learning module; separating the corresponding answer into several separate units; shuffling the separate units to obtain a shuffled sentence; and outputting the shuffled sentence to the user. After receiving spoken or written input from the user, the sentence-making language-learning module compares the answer given by the user with the answer to the question and outputs the comparison result to the user.

### BACKGROUND OF THE INVENTION

1. Field of the Invention

The invention relates to a computer-aided language-learning system. More specifically the invention relates to a system and method that utilizes interactive listening and speaking methodology and randomly makes questions and answers for users to improve their foreign language abilities.

2. Related Art

Currently, foreign language education to improve listening and speaking includes the following methods:

1. Through an electronic speech device or a teacher's voice, learners first listen carefully to contents arranged for a particular subject or some skill and then orally repeat the general ideas of the material or write down what they have heard. The answers from the learners are checked with answers provided in the material or by the teacher. The drawback of this method is that a learner cannot obtain immediate feedback about whether the answer he repeats or puts down is correct. It is also possible that a learner cannot complete the whole sentence simply because s/he is not familiar with a particular word.

2. With the advance in computer technology, some manufacturers have developed computer-aided learning materials with listening and speaking contents. These learning materials often are simply computerized from traditional printed materials. With the help of speech output devices, learners listen to contents arranged for a particular subject or some skill and try to comprehend by themselves. They then reply to questions provided by the lesson. The system determines whether the learners are correct or not according to the standard answers. Aside from the same drawback of being non-interactive, this method cannot accurately determine whether learners fully understand the material because the questions are of the multiple choice variety and learners may make guesses.

3. Students are separated into groups with at least two people. Group members start conversion practice on a specific topic and in a certain pattern. The problem with this method is that members who participate in the conversation are learners. They may have accents that make it difficult for others to understand them. It is also inappropriate to ask one member to judge whether other members are making progress.

Two common drawbacks in the first and second methods are: (1) Learners are often limited to specific topics, skills or modes in practice, yet conversions in daily life are often random and versatile. (2) Learners are limited to passively listening without interaction and actively expressing themselves. Learners cannot use their senses and thoughts to participate in learning activities and, therefore, often miss good opportunities to learn. Although the activities in the third method include bi-directional interactions, such interactions are performed among learners, who have limited language ability. Whether or not they have correct accents, are grammatically correct, or use words appropriately sometimes cannot be judged by any member in the group. Thus, the effect of this method is greatly reduced.

In view of the foregoing drawbacks in traditional foreign language training methods, a simple and convenient computer-aided language-learning system that utilizes mature computer techniques to conquer the problems of limited contents, insufficient interactions and inadequate instruction is highly desirable.

### SUMMARY OF THE INVENTION

In view of the foregoing, the invention provides a system and method that randomly makes question and answer sentences for users to enhancing their foreign language speaking and listening abilities. An object of the invention is to provide a training method that is suitable for both classroom teaching and self-learning to naturally increase students' listening and speaking abilities. During foreign language teaching, learners make sensible replies in speaking or writing to random questions provided by the computer in speaking or writing. This method can increase the learner's real-life listening comprehension and conversation abilities. It is also applicable to any person for learning any foreign language.

To achieve the above object, the computer-aided language-learning system that enhances learner's speaking and listening abilities in foreign languages through questions and answers includes a sentence pattern database comprising a plurality of questions and logical replies, a question-generating module, and a sentence-making language-learning module. The sentence pattern database is made of several question units, each question unit containing a question and at least one corresponding answer. The question-generating module randomly obtains one question from the sentence pattern database and sends the question and its corresponding answer to the learner. The sentence-making language-learning module outputs the question to the learner in speaking or writing. It also separates the corresponding answer into a plurality of separate units and shuffles the separate units to give the learner a shuffled sentence. After receiving spoken or written input from the learner, the sentence-making language-learning module compares the learner's input with its several answers and outputs the comparison result to the learner.

The disclosed method includes the steps of: establishing at least one sentence pattern sample in a sentence pattern database, outputting a question through a question-generating module, making the question through a sentence-making language-learning module, and completing the reply sentence by a user.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 is a system structure of the disclosed system for foreign language speaking and listening training by randomly making question and answer sentences;

FIG. 2-a is a flowchart of the disclosed method for foreign language speaking and listening training by randomly making question and answer sentences;

FIG. 2-b is a flowchart of the disclosed method for foreign language speaking and listening training by randomly making question and answer sentences;

FIG. 2-c is a flowchart of the disclosed method for foreign language speaking and listening training by randomly making question and answer sentences; and

FIG. 3 is a schematic view of the disclosed embodiment.

### DETAILED DESCRIPTION OF THE INVENTION

The invention provides a system and method for improving a user's foreign language speaking and listening abilities by randomly making question and answer sentences. A simple and intuitive computer-aided language-learning system is proposed to solve conventional problems in foreign language training in speaking and listening. A user answers in speech or text a random question provided by the computer system in speech or text by simply following the hints given by the system. The disclosed system and method can effectively increase the user's abilities in speaking and listening to a foreign language and aid his or her real-life conversation ability.

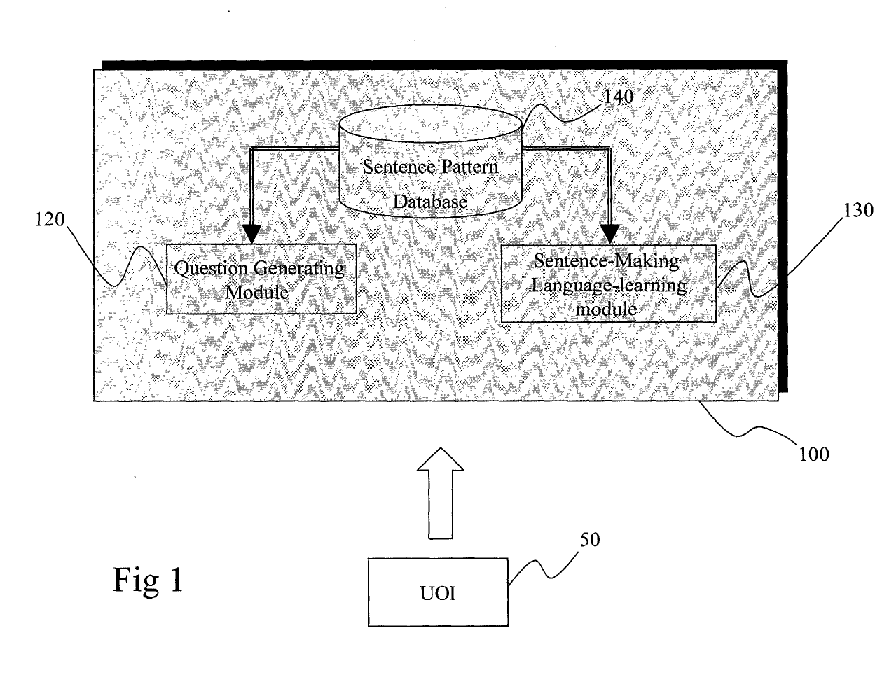

This specification uses a preferred embodiment to demonstrate the feasibility of the invention. With reference to FIG. 1, a conversational foreign language speaking and listening training system 100 processes all foreign language training. A user enters the system 100 by operating a UOI (User Operating Interface) 50. The UOI 50 can use a basic I/O (Input/Output) device to perform I/O, and the basic I/O device can be a keyboard, a mouse, a digital touch-control panel and a speech playing system. The conversational foreign language speaking and listening ability training system 100 includes (1) a question-generating module 120, (2) a sentence-making language-learning module 130, and (3) a sentence pattern database 140.

(1) The question-generating module 120 provides at least one question to the user. It uses a random number generator to generate a random number as the basis for generating the question. After receiving a call from a central monitoring module 110, a question signal is sent out from the question-generating module 120. The random number generator also provides a random number list for storing a random number series.

(2) The sentence-making language-learning module 130 determines whether the message input by the user is correct. After receiving a call from the central monitoring module 110, a sentence-making signal is sent out from the sentence-making language-learning module 130. The module 130 also provides a buffer and an adder. The buffer stores a comparison sample for comparing with the data in the adder. This comparison sample is the answer to some randomly generated question. The adder receives the message input by the user and processes according to the FCFS (First Come First Served) principle.

(3) The sentence pattern database 140 stores at least one sentence pattern sample. When a question signal and a sentence-making signal are detected, the sentence pattern sample data are linked to the question-generating module 120 and the sentence-making language-learning module 130.

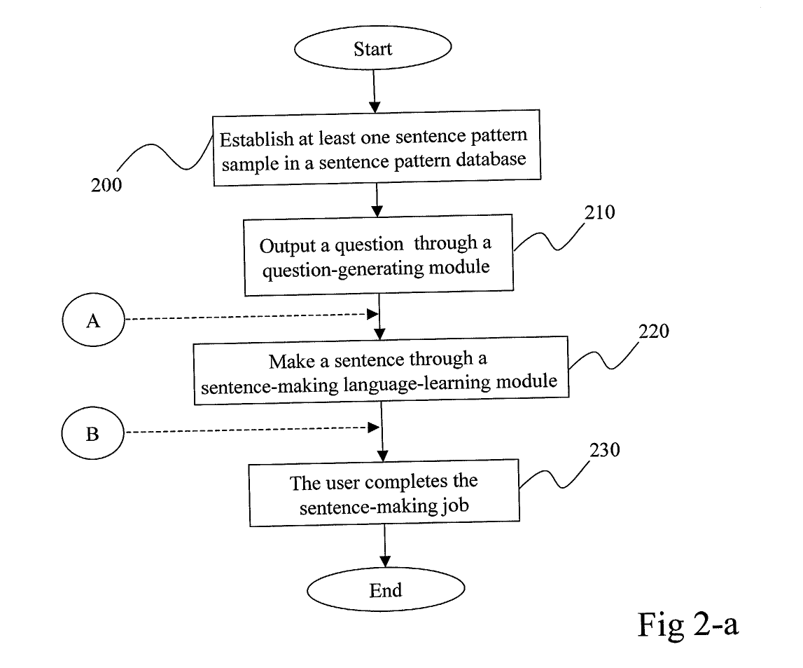

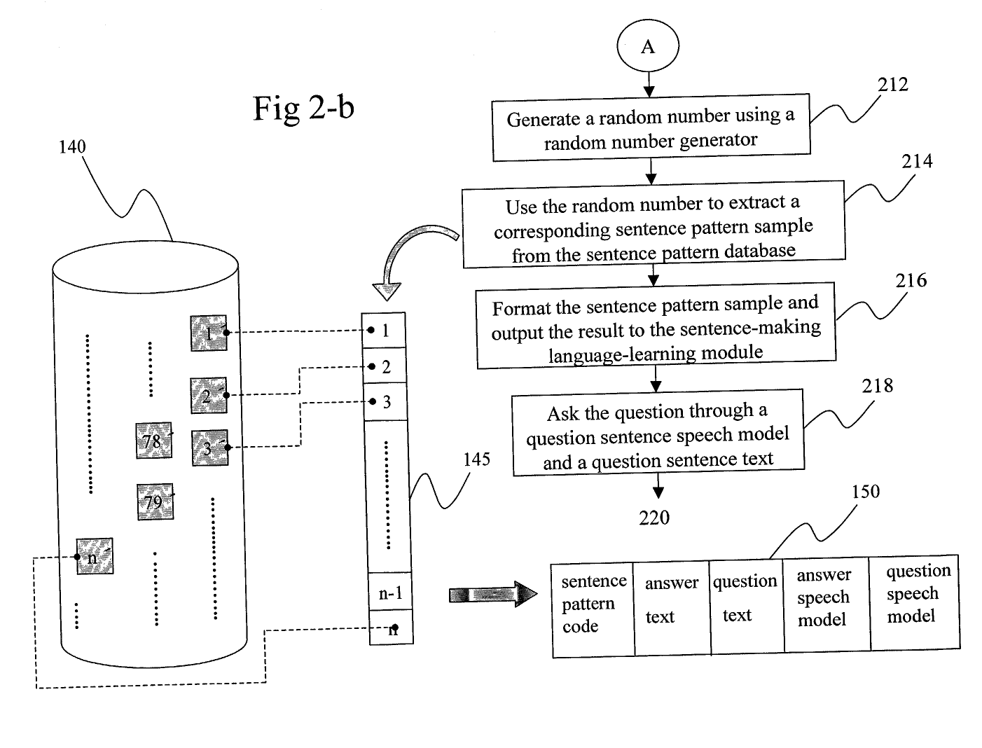

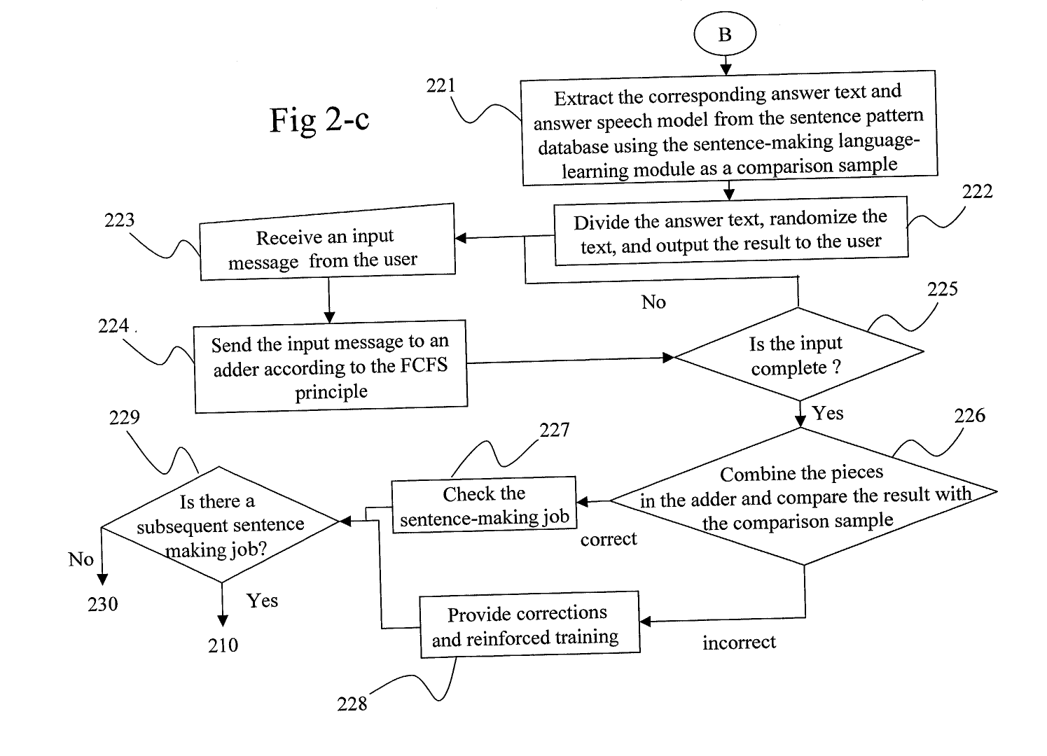

As shown in FIG. 2-b, the random number list 145 provides a random number series from 1 through n. Through a set of specific link relations, the random numbers are linked with the sentence pattern database 145. For example, 1 corresponds to 1′, 2 to 2′, etc. The sentence pattern database 140 also provides a sentence pattern data list 150 to store sentence pattern sample data. This sentence pattern data list 150 includes at least: (1) a sentence pattern code, which is the serial number of the sentence pattern sample data that corresponds to a random number; (2) an answer text, which is an answer presented in text; (3) a question text, which is a question presented in text; (4) an answer speech model, which is an answer presented in speech; and (5) a question speech model, which is a question presented in speech.

The conversational foreign language speaking and listening training system 100 can be run on any computer executable hardware platform. The computer executable hardware platform can be a PC (Personal Computer), an NB (Notebook), or a PDA (Personal Digital Assistant). Any person skilled in the art can make various equivalent modifications to implement the disclosed system 100 in other electronic devices or devices that can connect to a network.

With reference to FIG. 2-a, the procedure flow is as follows. First, at least one sentence pattern sample is established in a sentence pattern database 140 to define the sentence pattern database 140 (step 200). Afterwards, a question-generating module 120 outputs a question (step 210). The steps in the question-generating module 120 are detailed in step A. A sentence-making language-learning module 130 then performs a sentence-making job (step 220). The procedure in the sentence-making language-learning module 130 is detailed in step B. Finally, the user completes the sentence-making job (step 230) and ends the procedure.

As shown in FIG. 2-b, a random number generator generates a random number after step A (step 212). Afterwards, a sentence pattern sample datum is obtained from the sentence pattern database 140 according to the random number (step 214). The information about the sentence pattern sample datum has been described before and is not repeated here. The sentence pattern sample datum is formatted and output to the sentence-making language-learning module (step 216). Finally, the question speech model and the question text are employed to provide a question to the user (step 218). They are output through the UOI 50.

With reference to FIG. 2-c, the sentence-making language-learning module 130 obtains an answer text and an answer speech model from the sentence pattern database 140 as a comparison sample after step B (step 221). The comparison sample is stored in the buffer of the sentence-making language-learning module 130. Afterwards, the answer text is divided into individual words and shuffled, and the result is output to the user (step 222). The system then receives a message input from the user (step 223). The message, which can be a text or a speech, is then sent to an adder according to the FCFS principle (step 224). Step 225 determines whether the input is complete. If the input is not complete, step 223 is repeated until it is complete. If the input is complete, then pieces in the adder are combined and compared with the comparison sample (step 226). The pieces in the adder are arranged according to the message input by the user according to the FCFS principle. If the comparison result is correct, then a check sign is given to the sentence-making job (step 227), which means that the user answered correctly. If the comparison result is incorrect, then the system provides corrections and reinforced training (step 228) to prevent the user from making the same errors the next time. Finally, step 229 determines whether there is a subsequent sentence-making job. If there is, then step 210 is repeated until no sentence-making job is left. When there is no more sentence-making job, step 230 follows to end this procedure.

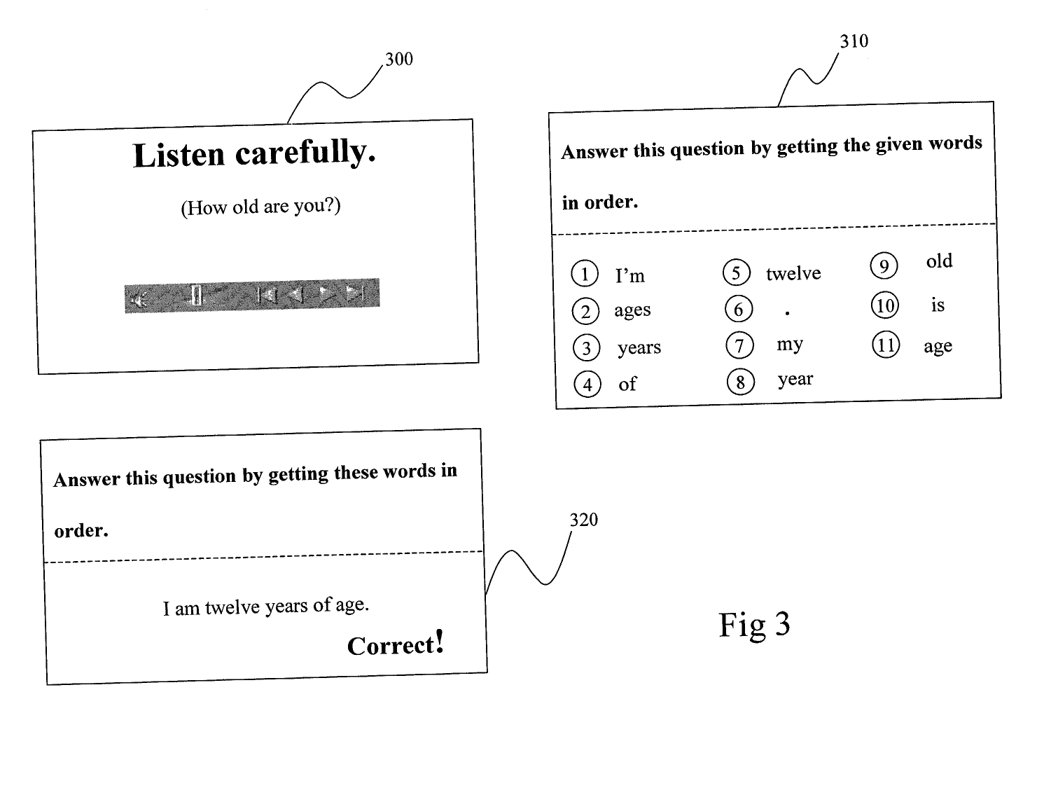

With reference to FIG. 3, through the interface window 300 provided by the invention, the user can answer questions according to the hints in the interface window 300. The interface window 300 provides questions by texts and speeches. The user can repeatedly play the questions and learn the pronunciation and intonation. The user then follows the hints 11 in the interface window 310 to make answers. In this embodiment, the question sentence is “How old are you?” The user needs to enter in speech or click numbers according to the word order s/he wants. After the user finishes ordering and presses the OK button to send out his or her answer, the system automatically compares the user's result with the comparison sample. If it is correct, the interface window 320 appears and the correct sentence is read out. Through this intuitive foreign language learning model, the invention can be used to learn any language in the world.

What is claimed is:

1. A system for training user's foreign language speaking and listening abilities by randomly providing question and answer sentences used in helping foreign language learning, including:
a conversational foreign language speaking and listening ability training system, which monitors the whole process; and
a UOI (User Operating Interface), which helps to accomplish the foreign language speaking and listening ability training;
wherein the conversational foreign language speaking and listening ability training system comprises:
a question-generating module, which generates a question signal according to a number generated by a random number generator and sends it to the user;
a sentence-making language-learning module, which generates a sentence-making signal when the question signal is received and determines whether the message input by the user is correct; and
a sentence pattern database, which stores at least one sentence pattern sample datum for the question-generating module and the sentence-making language-learning module to use.

2. The system of claim 1, wherein the random number generator provides a random number list for storing a random number series.

3. The system of claim 1, wherein the sentence-making language-learning module provides a buffer and an adder.

4. The system of claim 3, wherein the buffer stores a comparison sample for comparing with the data in the adder.

5. The system of claim 4, wherein the comparison sample is an answer corresponding to the randomly generated question.

6. The system of claim 3, wherein the adder receives a message input by the user and processes it according to the FCFS (First Come First Serve) principle.

7. The system of claim 1, wherein the sentence pattern database provides a sentence pattern data list for storing the sentence pattern sample data and the sentence pattern data list includes at least:
a sentence pattern code, which is a serial number of the sentence pattern sample data and corresponds to a random number;
an answer sentence text, which is an answer presented in text;
a question sentence text, which is a question presented in text;
an answer sentence speech model, which is an answer sentence presented in speech; and
a question sentence speech model, which is a question sentence presented in speech.

8. The system of claim 1, wherein the UOI uses a basic I/O (Input/Output) device to perform I/O and the basic I/O device is selected from a grouping consisting of a keyboard, a mouse, a digital touch-control panel, and a speech playing system.

9. The system of claim 1, wherein the conversational foreign language speaking and listening ability training system is used on a computer executable hardware platform selected from the group consisting of a PC (Personal Computer), an NB (Notebook), or a PDA (Personal Digital Assistant).

10. A method for training user's foreign language speaking and listening abilities by randomly providing question and answer sentences used in helping foreign language learning, utilizing a conversational foreign language speaking and listening ability training system to monitor the whole process and a UOI (User Operating Interface) to accomplish the foreign language speaking and listening ability training; the method comprising the steps of:
establishing at least one sentence pattern sample in a sentence pattern database;
using a question-generating module to output a question sentence;
using a sentence-making language learning module to perform a sentence-making job; and
waiting a user to complete the sentence-making job.

11. The method of claim 10, wherein the step of using a question-generating module to output a question sentence further includes the steps of:
using a random number generator to generate a random number;
obtaining a sentence pattern sample datum from the sentence pattern database according to the random number;
formatting the sentence pattern sample datum and output it to the sentence-making language-learning module; and
asking the user through a question sentence speech model and a question sentence text.

12. The method of claim 11, wherein the sentence pattern sample datum comprises:
a sentence pattern code, which is a serial number of the sentence pattern sample data and corresponds to a random number;
an answer sentence text, which is an answer presented in text;
a question sentence text, which is a question presented in text;
an answer sentence speech model, which is an answer sentence presented in speech; and
a question sentence speech model, which is a question sentence presented in speech.

13. The method of claim 11, wherein the random number generator is provided by the question-generating module.

14. The method of claim 10, wherein the step of using a sentence-making language learning module to perform a sentence-making job further includes the steps of:
using the sentence-making language-learning module to obtain an answer sentence text and an answer sentence speech model from the sentence pattern database as comparison sample;
dividing the answer sentence text into individual words, shuffling the words, and outputting the result to the user;
receiving an message input by the user;
sending the input message to an adder according to the FCFS principle;
determining whether the input is over;
combining pieces stored in the adder and comparing the result with the comparison sample; and
checking the sentence-making job.

15. The method of claim 14, wherein the adder receives and temporarily stores the message input by the user and processes the message according to the FCFS principle.

16. The method of claim 10, wherein the UOI uses a basic I/O (Input/Output) device to perform I/O and the basic I/O device is selected from a grouping consisting of a keyboard, a mouse, a digital touch-control panel, and a speech playing system.
